(19) United States
(12) Patent Application Publication
(10) Pub. No.: US 2018/0336311 A1
(43) Pub. Date: Nov. 22, 2018

(54) RESTORABLE LOSSY COMPRESSION METHOD FOR SIMILARITY NETWORKS

(71) Applicant: OFEK - ESHKOLOT RESEARCH AND DEVELOPMENT LTD, Karmiel (IL)

(72) Inventor: Zakharia FRENKEL, Haifa (IL)

(73) Assignee: OFEK-ESHKOLOT RESEARCH AND DEVELOPMENT LTD, Karmiel (IL)

(21) Appl. No.: 15/775,757

(22) PCT Filed: Nov. 10, 2016
(86) PCT No.: PCT/IL2016/051220

§ 371 Date: May 11, 2018

Related U.S. Application Data
(60) Provisional application No. 62/253,708, filed on Nov. 11, 2015.

(51) Int. Cl. G06F 19/16; G06F 19/24

(52) U.S. Cl. CPC G06F 19/16; G06F 19/24

(57) ABSTRACT

In a method of compressing a similarity network, the similarity network has nodes with a plurality of repetitions of characters sequences and a plurality of edges. Each edge connects a pair of the nodes based on a first similarity threshold. The method includes clustering of the nodes according to a second similarity threshold, where the second similarity threshold is higher than the first similarity threshold.

### FIELD OF THE DISCLOSED TECHNIQUE

The present invention relates generally to lossy compression of a network that can be quickly and fully or partially decompressed (fully restored), and more specifically to a method for reduction of required computer resources when using a very large network that comprises a similarity graph such as Protein Connectivity Network (PCN).

### BACKGROUND OF THE DISCLOSED TECHNIQUE

In a network that comprises a similarity graph there is similarity between neighboring nodes above a predefined threshold (e.g. 60%). An example of such similarity graph is a Protein Connectivity Network (“PCN”). A PCN is a graph that can be used in order to solve different problems of computational biology, mainly to assist in the prediction of protein structure and functionality. The PCN consists of nodes that are small fragments of protein sequences, and an edge between nodes reflects high similarity between fragments. Each node is described by an index, the protein it belongs to, and the offset of that protein.

If a protein database contains over 320,000 proteins, that builds up to more than 4.5×10⁷ nodes and over 4.7×10⁸ edges. The size of the graph requires massive storage space and executing queries is time consuming. For perspective, the STRING Consortium database presently has a collection of 9.6 million proteins covering a mere 2031 organisms. Now consider that here we are examining peptide fragments falling within certain selected ranges of amino acid residue length, and that each position can be any of 25 amino acid, and the fragments are potentially from random parts, with random overlaps of an otherwise unknown protein that we are seeking to characterize functionally. It's easy to see how massively complex, and resource-draining, a query to a naïve network can be.

### SUMMARY OF THE DISCLOSED TECHNIQUE

It is an object of the disclosed technique to provide a novel method for network lossy compression.

In accordance with the disclosed technique, there is thus provided a method of compressing a network characterized by nodes with a plurality of repetitions of characters sequences and a plurality of edges. Each edge in the network is connecting a pair of nodes based on a first similarity threshold. The method comprising clustering of said nodes according to a second similarity threshold, that is higher than said first similarity threshold.

According to some embodiments of the present invention, the method is for a network that is a Protein Connectivity Network (“PCN”).

According to some other embodiments of the present invention, the method further comprising the following steps: calculating similarity value between the nodes of each edge to identify nodes having similarity above the second similarity threshold value and performing the following steps for the identified nodes: (i) confirming whether the identified nodes are associated to a cluster; (ii) creating new clusters for identified nodes not previously associated to a cluster, and assigning the new cluster as root cluster; (iii) adding an unassociated node to the root cluster of an associated node in case only one node is associated to a cluster, as long as the number of nodes associated to the root cluster of the associated node is less than a predefined value; and (iv) merging two root clusters of the nodes of edge into one of the clusters in case the two nodes are associated to different root clusters, and sum of numbers of nodes associated to these root clusters is less than the predefined value.

According to some other embodiments of the present invention the method further comprising creating an empty dynamic list for cluster entries, each cluster entry comprising a pointer variable pointing to a parent cluster and a node number variable corresponding to the number of nodes in a cluster; (a) creating a list of node entries, each node entry comprising a variable indicating the cluster number of the node is assigned to, and variable is initialized as unassigned; (b) the creating of new cluster further includes: defining a new entry in the list of clusters, as a root cluster with number of nodes equal two; and (ii) associating both nodes to the root cluster by associating corresponding nodes entry in the list of nodes to the root cluster. (c) the adding of unassociated node to the root cluster of an associated node further includes: (i) searching for the root cluster of the node already associated to this cluster; (ii) updating the corresponding pointer to the parent cluster in the list of clusters to point to the root cluster; and (iii) adding the node to the cluster when the adding of the unassociated node to the root cluster doesn't exceed the predefined value by increasing the number of nodes in the corresponding entry in the list of clusters by one; and updating the cluster that the node is associated to, in the corresponding entry of the node.

(d) the merging of two root clusters into one of the clusters further includes
i) searching for the root clusters of the both nodes;
ii) calculating the sum of nodes associated with these clusters; if the sum is less than a predefined value, than performing the following steps:
i) updating the pointer of the root cluster with larger index in the corresponding root cluster in the list of clusters to point to the other root cluster;
ii) setting the number of nodes in the corresponding entry in the list of clusters to the sum of the nodes set in the corresponding clusters in the list of clusters; and
iii) updating the corresponding pointer to the parent cluster in the list of clusters to point to the residuary root cluster, for each cluster passing through when searching for the root clusters.

According to some other embodiments of the present invention the method further comprising: a) calculating amount of root clusters; b) renumbering the clusters; c) associating of nodes with new numbers of clusters (after renumbering); d) creating an output file of content of clusters; and e) building connections between the clusters for each said edge where nodes of said edges are connected to different clusters.

### BRIEF DESCRIPTION OF THE DRAWINGS

The disclosed technique will be understood and appreciated more fully from the following detailed description taken in conjunction with the drawings in which:

FIG. 1 is a table of network reduction in relation to second similarity threshold;

FIG. 2 is a table of nodes and cluster number in relation to second similarity threshold;

FIG. 3A is a table of restoration time Vs. second similarity threshold;

FIG. 3B is a graph of network restoration time in minutes Vs second similarity threshold;

FIG. 4A is a table of number of edges Vs. size of max cluster;

FIG. 4B is a graph of Number of edges Vs. size of max cluster;

FIG. 5A is a table of overall disk size consumption Vs size of maximum clusters;

FIG. 5B is a graph of overall disk size consumption Vs size of maximum clusters;

FIG. 6A is a table of network restoration time Vs size of maximum clusters;

FIG. 6B is a graph of network restoration time Vs size of maximum clusters;

FIG. 7A is a table of number of clusters Vs. max cluster size;

FIG. 7B is a graph of number of clusters Vs. size of max cluster;

FIG. 8A is a table of build time vs size of max cluster;

FIG. 8B is a graph of build time vs size of max cluster;

FIG. 9A is a table of disk size reduction vs. level of second similarity threshold;

FIG. 9B is a graph of disk reduction in relation to level of second similarity threshold;

FIG. 10 illustrates the clustering technique;

FIG. 11 is a schematic illustration of the method for compression in an embodiment of the present invention;

FIG. 12A-12E is a flow chart explaining the steps of a method for compression in an embodiment of the present invention; and

FIG. 13 is a flow chart explaining the steps of an alternative method for compression in an embodiment of the present invention.

### DETAILED DESCRIPTION OF THE EMBODIMENTS

As mentioned hereinabove, it is an object of the disclosed technique to provide a novel method for network lossy compression. There is thus provided a method of compressing a network characterized by nodes with a plurality of repetitions of characters sequences and a plurality of edges. Each edge in the network is connecting a pair of nodes based on a first similarity threshold. The method comprising clustering of said nodes according to a second similarity threshold, that is higher than said first similarity threshold.

The present invention provides an implementation of an efficient platform to execute queries on a reduced network, thus allowing researchers around the globe to use the network in their own research easily and quickly. The reduced network is generated by using compression techniques, such as multilevel approaches based on graph clustering, while allowing an efficient way to quickly restore it (fully or partially) for use in queries and for navigational needs.

A network, as used herein means a “similarity network” characterized by nodes having some attributes (for examples, words of some text, coordinates, and so on) and with some function defined on these attributes allowing to calculate a similarity (or distance) between each pair of nodes (for example, hamming distance for words, Euclidian distance for coordinates and so on); and plurality of edges, each edge connecting a pair of said nodes based on some similarity (or distance) threshold.

The term “node” or “sequence fragment” or “sub sequence” refers hereinafter to a sequence of characters.

As used herein, the term “protein fragment” refers hereinafter to a protein sequence or a part thereof comprising less than about 25 amino acids, and preferably between about 15 to 25 amino acids, and more particularly about 20 amino acids.

The term “root cluster” means that the cluster does not point to (i.e. does not included into) another cluster, wherein other clusters can point on it.

The term “parent cluster” means the cluster, which some another cluster points on it.

The term “usual cluster” refers hereinafter to any cluster in a tree that is not root cluster.

The term “child cluster” refers hereinafter to a cluster which points to another cluster.

The term “hamming distance” refers hereinafter to the number of positions between two strings of equal length at which the corresponding symbols are different. In other words, it measures the minimum number of substitutions required to change one string into the other, or the minimum number of errors that could have transformed one string into the other.

In the context of the present invention, the term string refers to a sequence of characters. In a non-limiting example of PCN the term string refers to protein sequence or protein fragment, preferably comprising about 20 amino acids and the terms position or symbol refers to a single amino acid within the protein fragment or sequence.

The term “first similarity threshold” refers to the similarity value between the nodes in the original network. For example, in PCN, the similarity value between the nodes corresponding to the protein sequence fragments in the network may be determined according to a hamming distance between two protein sequence fragments or may be determined according to any other similarity calculation method. If this value is higher or equal than the first similarity threshold, for example 60% of identity, the nodes are connected by edge and become neighboring.

The term “second similarity threshold” refers to the similarity threshold that influences the construction of clusters in the compressed network. It defines when joining of two neighboring nodes into the same cluster should happen.

The term “edge” is defined hereinafter as the link between the corresponding nodes of protein fragments having sufficiently high sequence-wise similarity to satisfy a predefined threshold. According to one exemplary embodiment, an edge is defined as the link between nodes of amino acid sequence similarity of 60% or more.

The term “relatedness” or “resistance” refers hereinafter to similarity or dissimilarity between nodes in a network and in PCN to protein fragments or sequences, determined according to predefined weights or properties.

The term “lossy compression” refers to usage of approximate data or partial data to demonstrate content.

As described hereinabove, an example of such a huge network is a Protein Connectivity Network (“PCN”). A PCN can be very large in size, requiring many gigabytes of memory, both persistent and active, and consuming a considerable amount of computing resources and runtime when used for executing queries.

The purpose of the present invention is to compress such a very large network characterized by a first similarity threshold between neighboring nodes and nodes with a plurality of repetitions of sequence of characters, by using a clustering algorithm.

A compression is performed by dividing a huge network such as PCN into a set of clusters, where the clusters are considered as super-nodes in the compressed network. Based on similar method as in the multilevel approach described in “Proc. of the 6th SEAM Conference on Parallel Processing for Scientific Computing, 1993, 445-452; Hendrickson and Leland, A Multilevel Algorithm for Partitioning Graphs, Tech. report SAND 93-1301, Sandia National Laboratories, Albuquerque, N. Mex., 1993”, where the super-nodes are calculated as clusters.

In the new compressed network only information about clusters content and connections (clusters are connected if at least one connection between correspondent nodes of the clusters exists in the original network). This approach conserves a significant amount of space, while maintaining the general structure of the network. In other words, the disclosed technique is creating a smaller graph in which each group of nodes is well connected and loose nodes are removed.

The compression is achieved by eliminating the need to save internal edges between the clusters and edges of multiple connections of any two clusters (i.e. if two clusters are connected by several edges—it will correspond to only one edge in the compressed network).

In other words, the compression is based mainly on omitting all edges between two nodes inside a cluster. It is effective because restoring the edges is performed by calculating the similarity between relatively small finite groups. However this approach has two implications. On one hand, if the clusters are too small and only a small amount of edges can be removed then, a very small compression of the network may be generated. On the other hand, if the clusters are too big, restoring them to the original network state won't be feasible in a reasonably reduced amount of time. Therefore, in order to prevent generation of huge clusters the size of the clusters is limited to maximal size which is defined by the user.

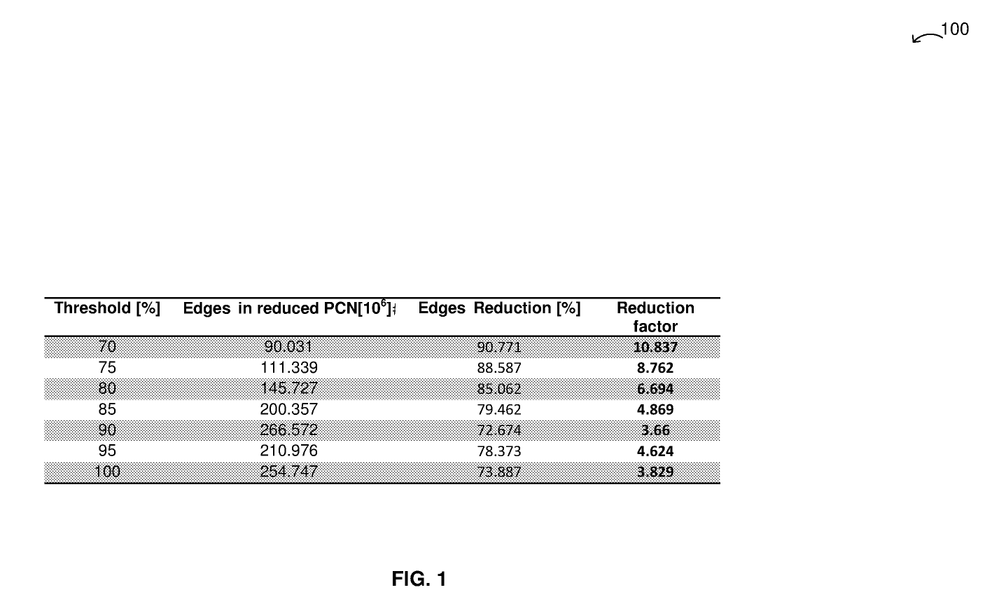

FIG. 1 is a table of PCN reduction in relation to the value of second similarity threshold, where reduction factor is defined as old size divided by new size. One can see that the number of edges in the original symmetric PCN had 975.54×10⁶ and the number of edges in the original (none-symmetric) PCN had 478.77×10¹³ was significantly reduced.

In an exemplary embodiment, one approach to handle interconnecting edges between two different clusters or between a cluster to an external node may comprise retaining only one edge between connected clusters. While this approach may yield a great compression of the network, it may also cause a much longer recovery time since the similarity between each node pair within the connected clusters has to be calculated.

Another exemplary embodiment of the present invention includes putting a weight on the edge between clusters that indicates how many interconnecting edges there are.

The present invention may be very effective for similarity graphs in general and specifically for PCN, because high level of compression can be achieved. Moreover, the original network can be quickly reconstructed in spite the fact that the compression is “lossy”. The extremely fast run time of the decompression is due to (i) an indication that time of reconstruction of the edges in similarity graphs is o(n²), where n is amount of nodes, so, the reconstruction for many small groups (clusters) can be much quicker than for one large group (whole graph); and (ii) an effective approach for clustering with limiting of the maximal size of cluster the data lost was not great compared to the compression achieved. Loading the reduced network into memory allows performing very fast traversing queries over the network with little or no overhead of redundant input/output calls.

Additionally, there are many tasks where the compressed network can be used without first being decompressed. For example, the task of sequence annotation of proteins does not require reconstruction of the original network from the compressed network, i.e. it may be performed on a compressed network.

Compressing a very large PCN, on the order of several gigabytes in size down, to mere tens of megabytes in size according to the disclosed techniques, enables storing, searching, and querying such a very large PCN efficiently and relatively quickly. The entire reduced PCN may be loaded into a machine's operating memory and runtime complexity of compression is linear with the number of edges. A node in the network represents a protein sequence or a fragment or subsequence thereof. A node in the network may be bound by edges to one or more other protein sequences represented by nodes in the network.

An embodiment of the present invention will be explained below referring to the drawings.

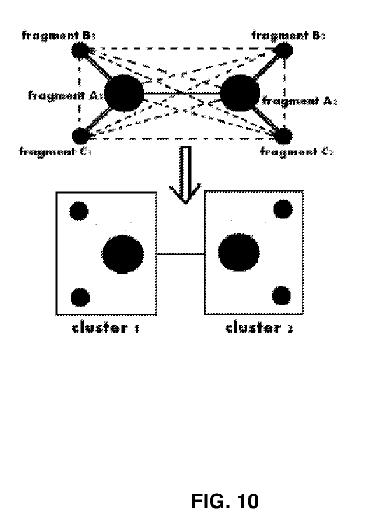

FIG. 10 illustrates the adding of close relatives (fragment B1, C1,and B2, C2) to a pair connected nodes or protein fragments (nodes A1 and A2) and may add to the original network up to 10 new connections (dashed lines). Joining of these close relatives to clusters (cluster 1, cluster 2) and connecting between the two clusters yields the compressed network.

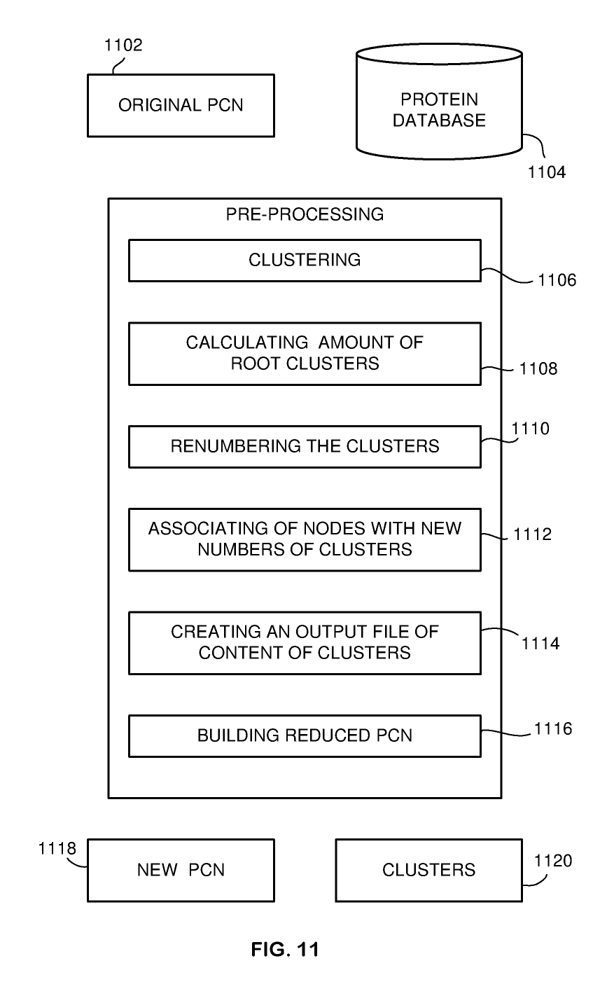

As shown in FIG. 11, the input includes a given original PCN network 1102 and a protein database 1104. The original PCN 1102 consists of nodes that are small fragments of protein sequences, and an edge between nodes reflects high similarity between fragments. Each node is described by the index the protein it belongs to and the offset of that protein.

In an exemplary embodiment of the invention, where the network is a PCN, one purpose of the disclosed method is to build subgraphs of the original PCN using “biologically justified” or rational clusters as sub-graphs of the original PCN which consists of nodes connected with edges with first similarity threshold value, i.e., edges connecting nodes (i.e. peptide sequences) with higher similarity threshold value than the similarity threshold value in the original PCN.

The calculations of similarity are based on the finding of connected components of subgraph from the original network based on the increased similarity threshold. The similarity can be calculated on the base of the hamming distance (see Damian Szklarczyk, Andrea Franceschini, Michael Kuhn, Milan Simonovic, “The STRING database in 2011: Functional,” Nucleic Acids Research, vol. 39, pp. 561-568, 2011) or on the resistance value of the corresponding edge or may be calculated according to any other method.

Exemplary embodiments of the present invention may use an electrical model for defining relatedness through a network. This approach takes into account the network parameters, as they directly influence on electric properties that represent connectivity through the network. Such properties include conductivity or, oppositely, resistance. The approach has been more fully disclosed in “Frenkel, Zakharia, Zeev Frenkel, Edward Trifonov a Sagi Snir. Structural relatedness via flow networks in protein sequence space. Journal of Theoretical Biology, London: Elsevier, 2009, Vol. 260, July, p. 438-444. ISSN 0022-5193.”

The resistance through the network is further calculated by dividing the voltage by the current through the network. In a specific case the resistance is calculated as follows:

(1) An electrical voltage of 1V between the nodes of interest is considered.

(2) The electrical current i between the nodes is calculated. The current through the network may be calculated by the Ohm's and Kirchhoff's current laws.

(3) The resistance through the network is further calculated by dividing the voltage by the current through the network. Increasing resistance indicates decreasing similarity and vise versa.

To compress the original network into a reduced network consisting of clusters, the following steps are performed and include:

Clustering 1106;

Calculating the amount of root clusters 1108;

Renumbering of the clusters 1110;

Associating of nodes with new numbers of clusters (after renumbering) 1112;

Creating an output file of content of clusters 1114; and

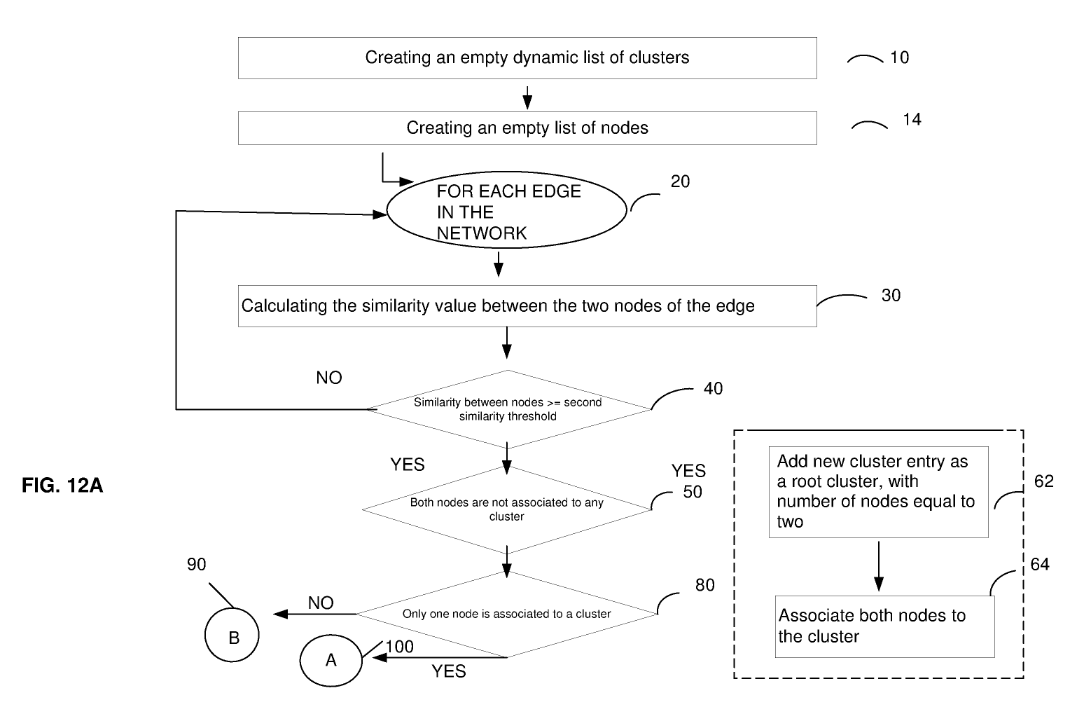

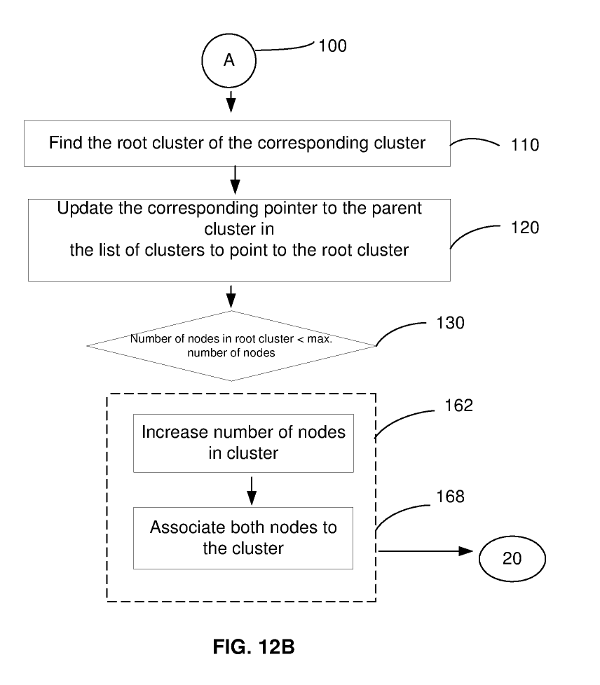

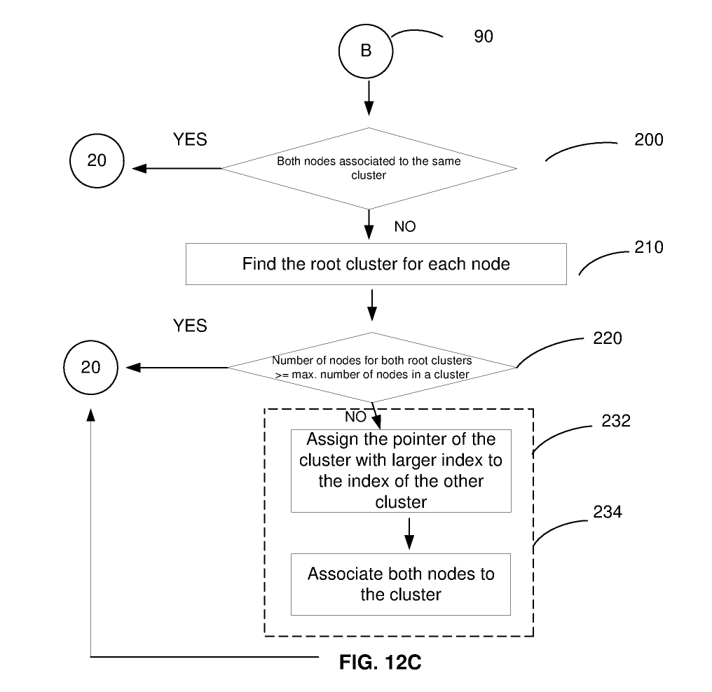

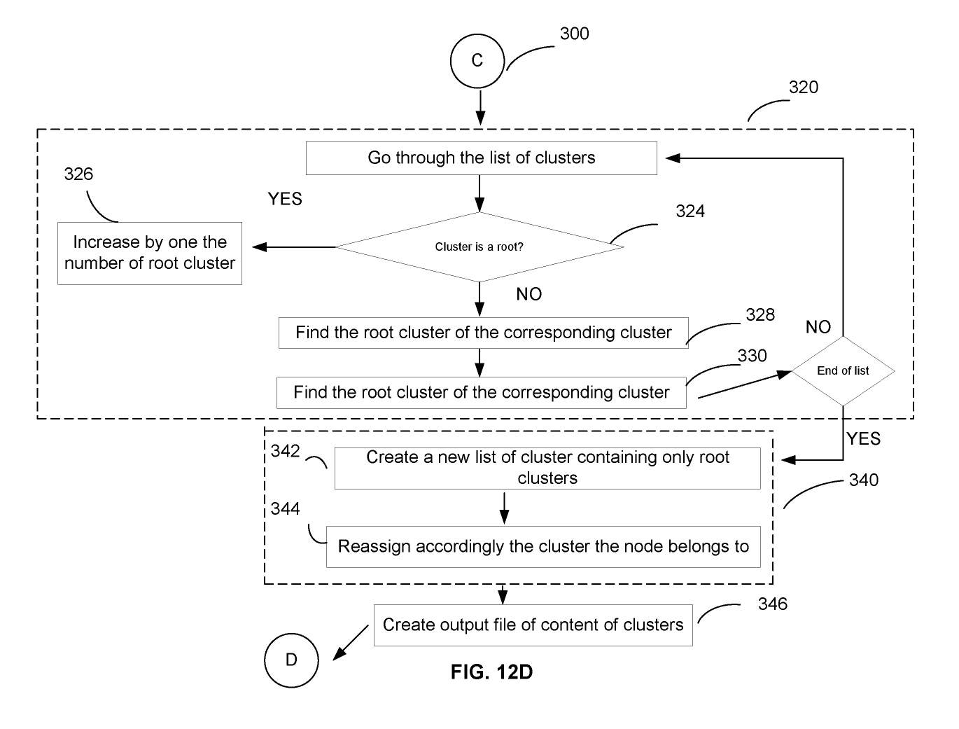

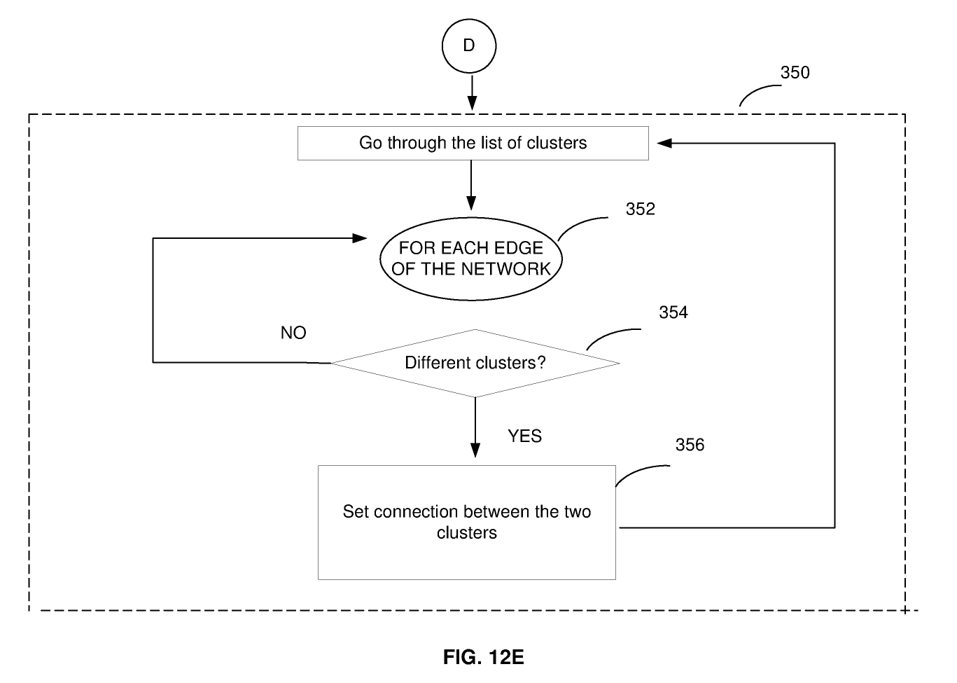

building connections between the clusters for each said edge where nodes of said edges are connected to different clusters 1116 to yield a new PCN 1118 clusters 1120 and are detailed below with reference to FIGS. 12A-12E.

### Clustering

Clustering process begins with creating an empty dynamic list of clusters 10. The structure of the clusters list is as follows: for each cluster, the first member of an entry is a variable used to indicate a pointer to the parent cluster (or indicating that the cluster is a root, for the case of pointer is null or pointing to itself), the second member of the structure signifies the number of nodes in this cluster.

After the creating of an empty dynamic list of clusters, comes the step of creating an empty list of nodes 14. The structure of the list of nodes is as follows: for each node, a variable indicating the cluster number or pointer to the duster, that the node is assigned to, initialized to unassigned duster.

Computer resources, such as running time, i.e. building time of the compressed network and restoration time, along with disk space consumption (for the compressed network) may be affected by two parameters: a) the second similarity threshold; and b) maximum number of nodes in each cluster.

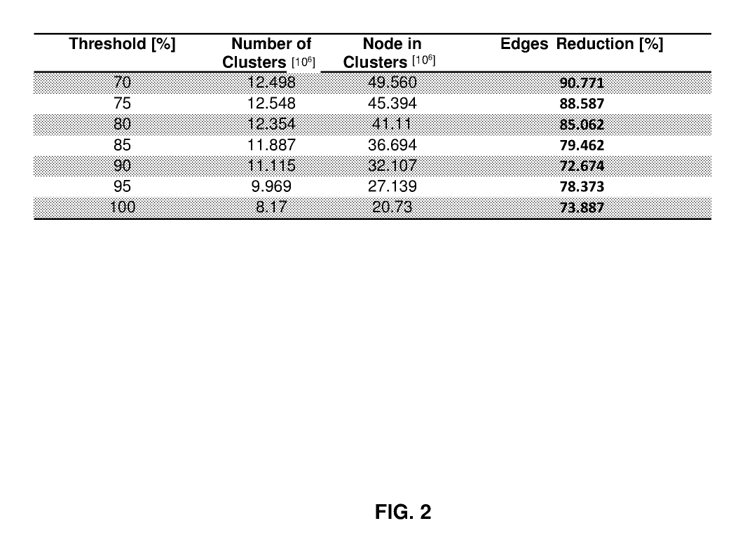

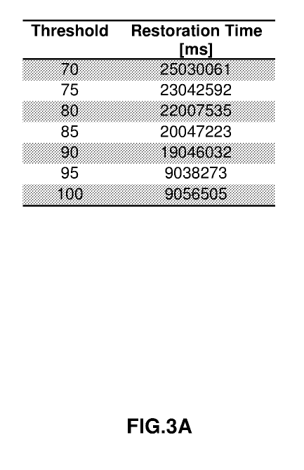

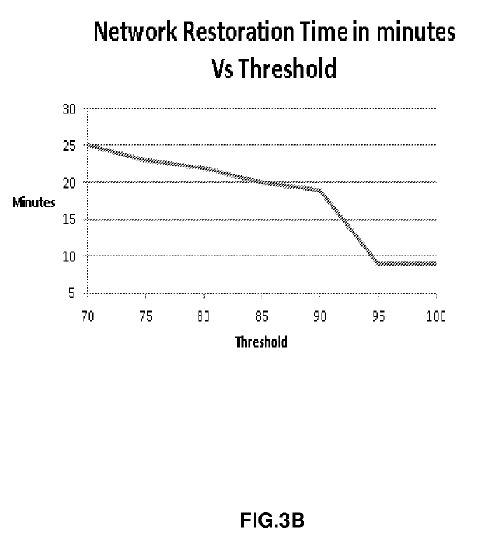

FIGS. 2, 3A and 3B shows the impact of second similarity threshold on the size of the compressed network and on restoration time.

In FIG. 2 one can see that the higher the second similarity threshold, the lower the number of clusters, nodes and edges in the compressed network.

FIGS. 3A and 3B represent restoration time Vs. second similarity threshold. The higher the second similarity threshold the faster restoration time.

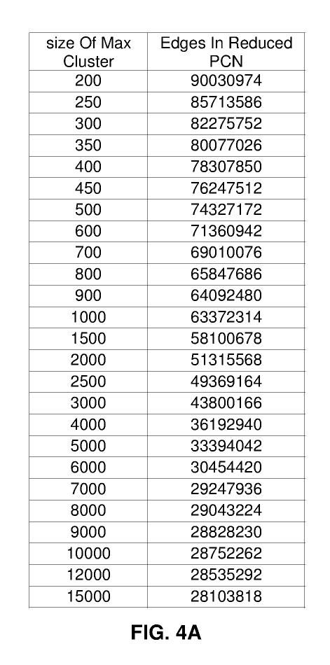

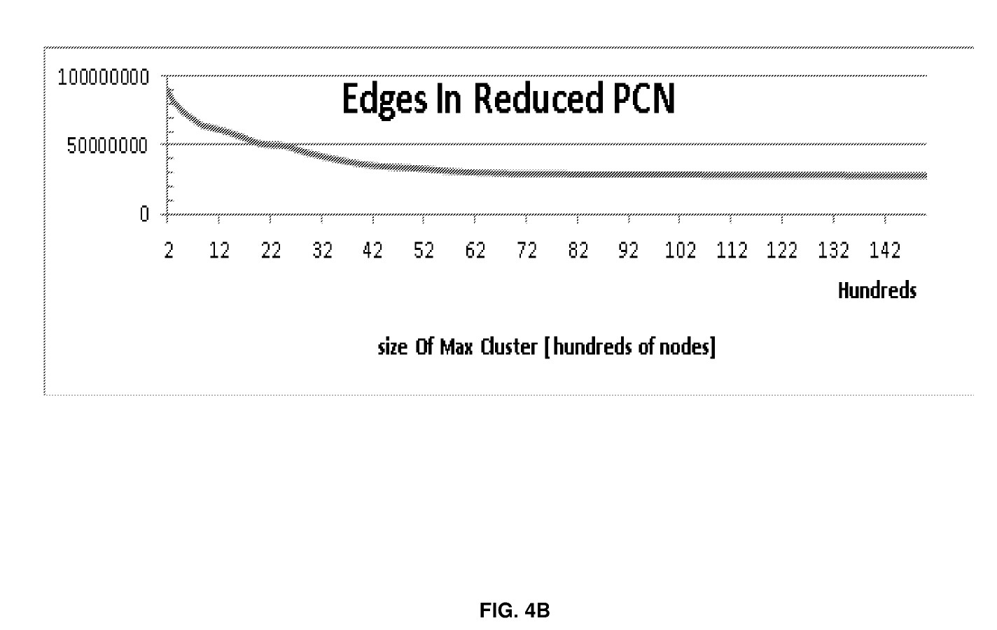

FIGS. 4A-8B demonstrate the impact of maximum number of nodes in each cluster on:

the number of edges in the compressed network;

disk consumption;

restoration time;

number of clusters; and

building time.

FIGS. 4A-4B show that the number of edges is reduced as size of max cluster increases.

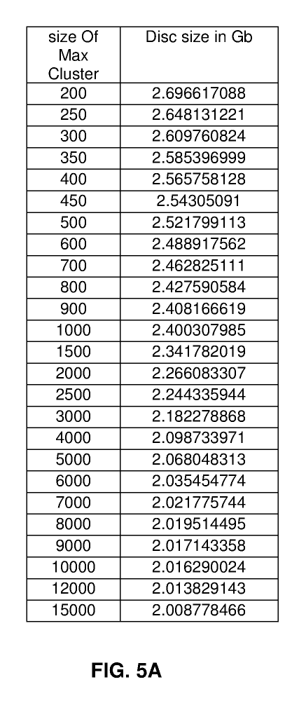

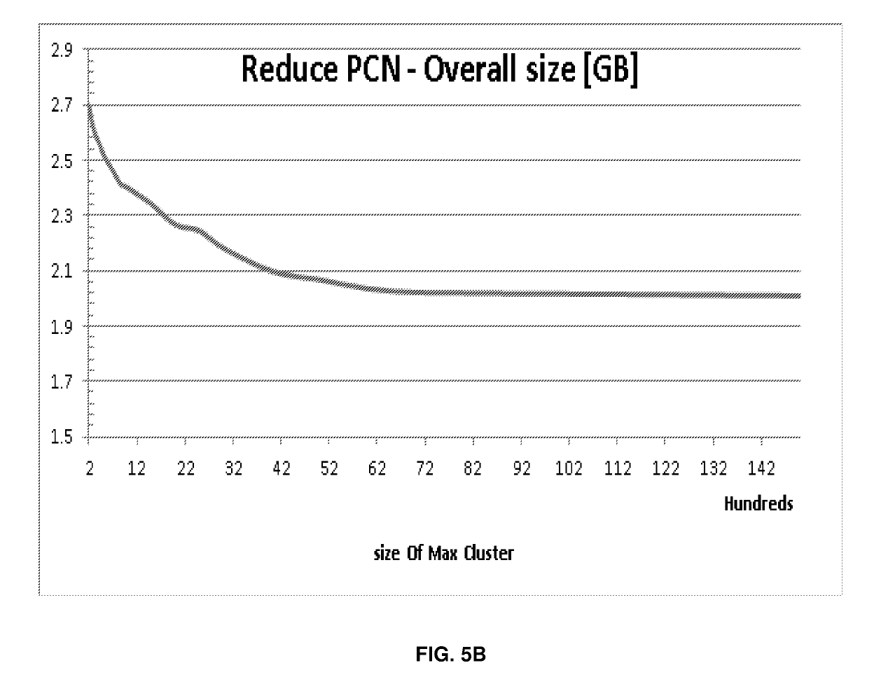

FIGS. 5A-5B show a reduction in overall disk size consumption as size of maximum clusters increases;

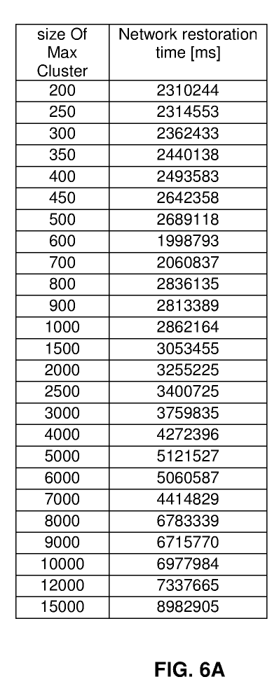

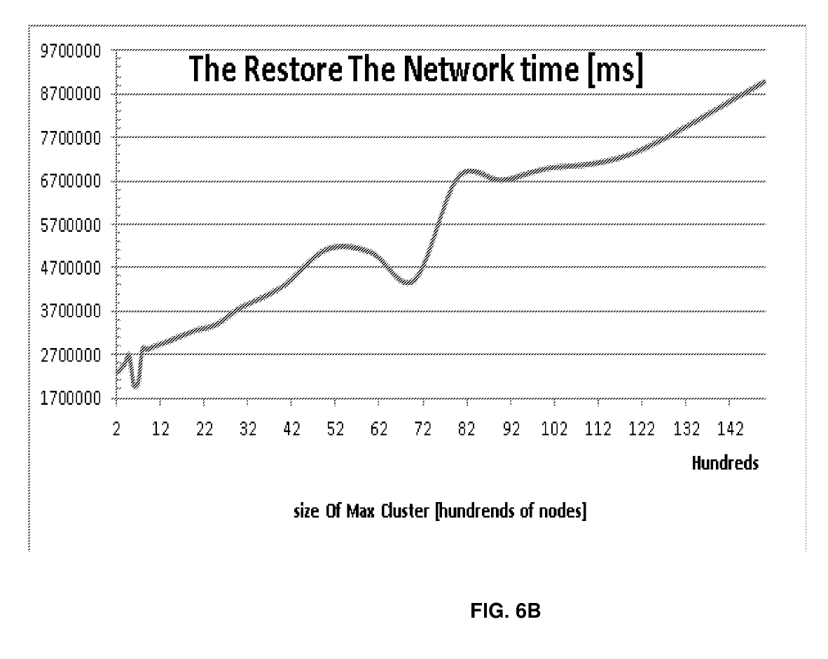

FIGS. 6A-6B show increase in restoration time as size of maximum clusters is increased.

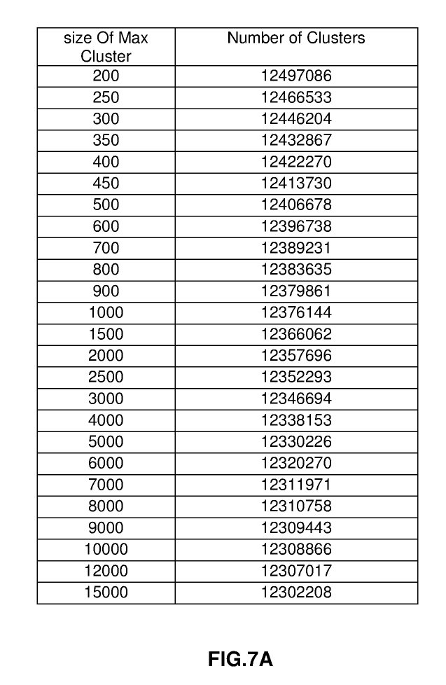

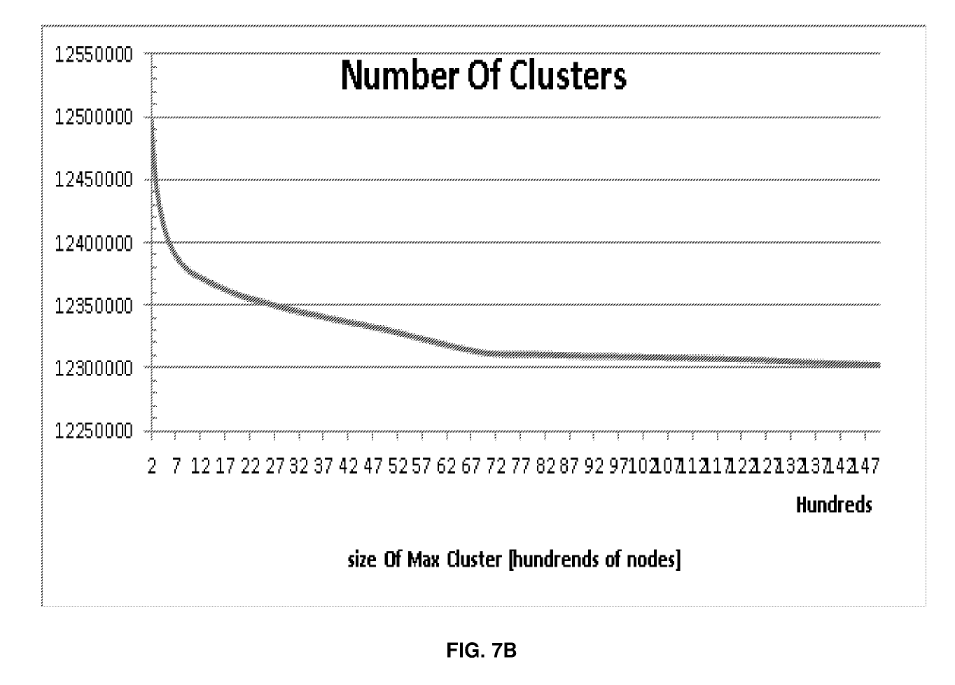

FIGS. 7A-7B show that the number of clusters decreases as max cluster size increases.

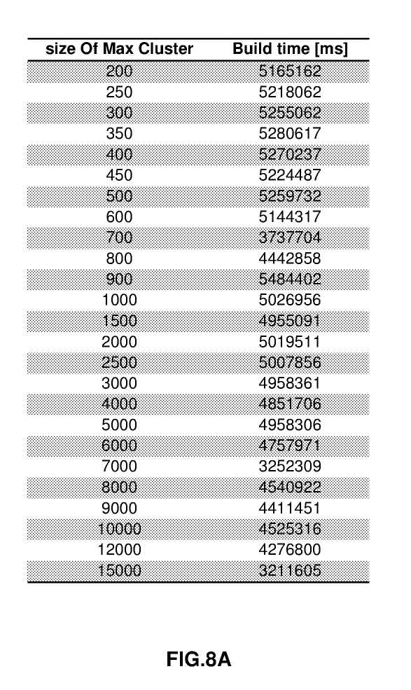

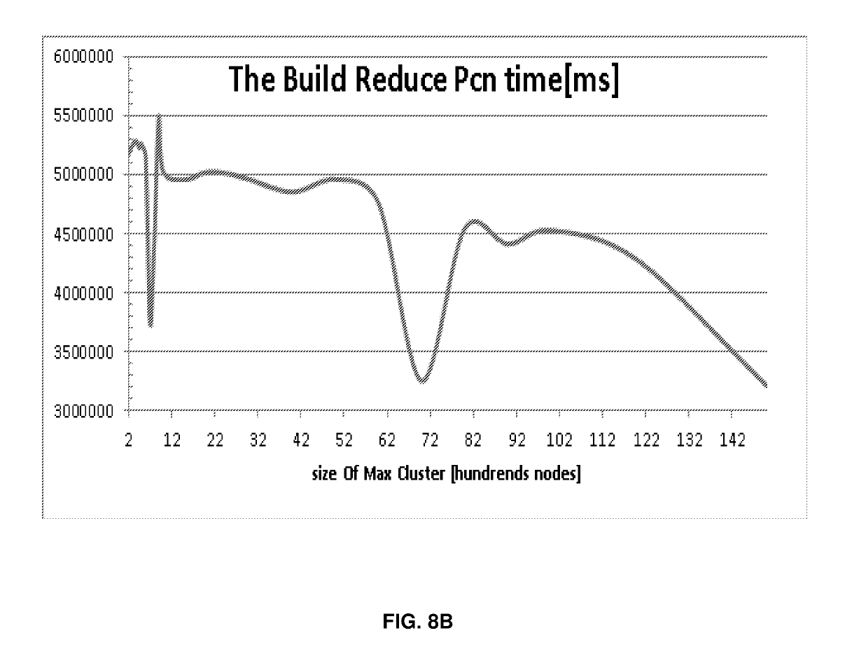

FIGS. 8A-8B shows that build time of the compressed network is optimal in a certain size of max cluster size;

A second similarity threshold value for sequence similarity (for the construction of clusters in the compressed network) is predefined. The second similarity threshold value is above the first similarity threshold value in the network before the compression.

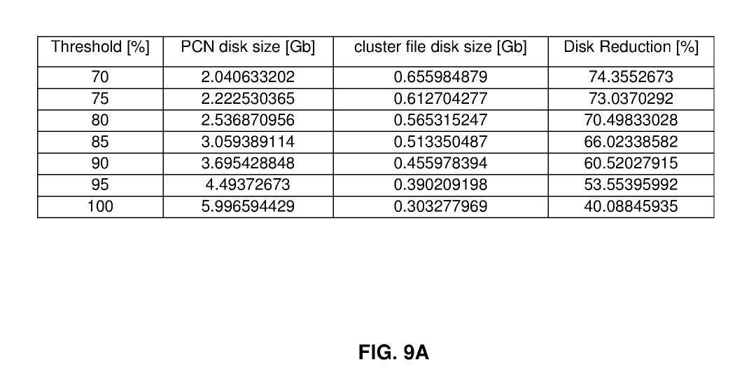

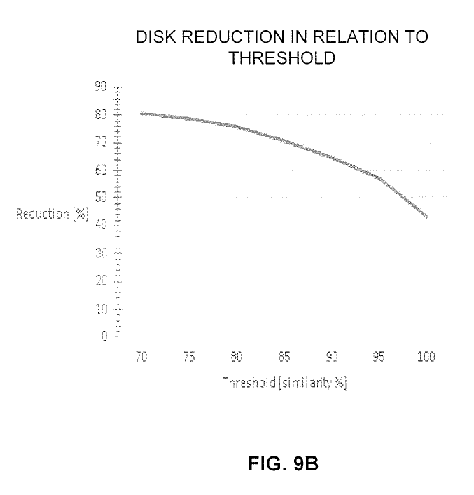

FIG. 9A is a table of disk size reduction vs. level of second similarity threshold.

FIG. 9B is a graph of disk reduction in relation to level of second similarity threshold.

Restoring clusters with large amount of nodes will no longer be feasible in a reasonable time frame. Therefore, to prevent huge clusters (i.e. having large number of nodes) the size of the clusters is limited to a pre-set maximal size. A threshold value for a maximal number of nodes in a cluster is predefined. A user may select the parameters according to needs of speed of decompression, size and available disk space.

Thus, for example, in PCN where each position in a protein sequence can be filled with any of 20 amino acid letter values, a researcher skilled in the art may set the second similarity threshold for protein sequence similarity of 80%-90%.

When the clustering of the nodes is performed, for each edge of the original network 20, the following steps are performed:
1) Calculating the similarity value between the two nodes of that edge 30 (by any method, examples to methods are described further hereinbelow).
2) If the nodes (peptide fragments) are similar (i.e. ≥second similarity threshold), check if the nodes belonging to the edge are already associated to any cluster 40.
   Different use cases are described below:
   2.1) Where both nodes are not associated to any cluster 50, a new cluster is created 60, as follows:
      2.1.1) define a new entry in the list of clusters: the new cluster entry is defined as a root cluster (meaning pointing to itself), with number of nodes equal to two 62.
      2.1.2) associate both nodes to this cluster: associate the corresponding nodes entry in the list of nodes to this new cluster 64.
   2.2) Where only one of the edge's nodes is associated to a cluster 80, the unassociated node is added to the root cluster of the associated node. This is possible only when the number of nodes associated to that cluster is less than maximal number of nodes in a cluster. The method comprises:
      2.2.1) searching for the root cluster of the node already associated to this cluster 110, by a) going to the parent cluster and checking whether this is the root cluster; and
         b) Repeat step (a) until achieve the root cluster;
      2.2.2) updating the corresponding pointer to the parent cluster (sometimes for some parent clusters, one pointing to another) in the list of clusters to point to the root cluster, doing so for each cluster viewed when searching for the root cluster 120;
      2.2.3) checking that maximal number of nodes in a cluster will not be exceeded by adding the unassociated node to the root cluster.
         Two use cases are described below:
            2.3.2.1) case 1: the unassociated node can be added to this cluster 160, add the node to this cluster by
            increasing the number of nodes in the corresponding entry in the list of clusters by one 162; and
            updating the cluster the node is associated to, in the corresponding entry of the node 168.
            2.3.2.2) case 2: the unassociated node cannot be added to this cluster 140, so skip the node and go to the next edge.
   2.3) Both nodes are associated to a cluster 90. In this case, if the nodes are associated to different clusters, the purpose is to merge the two clusters. This is possible only where the sum of the number of nodes associated to these clusters is less than the maximal number of nodes in a cluster. (If the clusters are the same, go to the next edge). The steps are as follows:
      2.3.1) searching for the root cluster of each one of the nodes 210; and
      2.3.2) checking if the clusters can be merged, based on the sum of the number of nodes corresponding to these clusters in the list of clusters and maximal number of nodes in a cluster 220.
         Two use cases are described as below:
            2.3.2.1) case 1: the clusters can be merged 230, so merge one of the clusters to root cluster of the second cluster by:
            updating the pointer of the cluster with larger index to point to the other cluster 232. Meaning, the cluster with larger index is becoming a child of the other cluster. Similarly, the pointer should be updated in the child cluster one of the nodes 210 (and its other parents clusters, if present) and
            setting the number of nodes in root cluster of the other cluster to the sum of the nodes of the two clusters 234.
            2.3.2.2) case 2: the clusters can't be merged, (sum of the number of nodes corresponding to these clusters≥maximal number of nodes in a cluster) take no action (i.e. go to the next edge).

### Calculating the Amount of Root Clusters

Referring to FIG. 12D, Input C 300 is from the output of the edge-checking process in FIG. 12A. Calculating the amount of root clusters 320 for each cluster in the list of clusters 322, perform the following steps:

checking if the cluster is a root cluster 324 by either:
[a] use case 1: the cluster is a root cluster:
   increase the number of root cluster by 1 326, or
[b] use case 2: the cluster is not a root cluster:
   search for the root cluster of the corresponding cluster 328 and for each cluster we went through when searching for the root cluster, updating the corresponding pointer to the parent cluster in the list of clusters to point to the root cluster 330.

### Renumbering of the Clusters

The purpose of renumbering of the clusters 340 is to create a new list of clusters that contains only root clusters, and reassign nodes to this list.

Creating a new list of clusters containing only the root clusters 342.

For each node in the list of nodes, reassigning accordingly the cluster the node is associated to 344.

Creating an output file of content of clusters 346.

### Building the Reduced PCN

The clusters that were found are used to create a reduced network which does not include any edges inside the clusters. These removed edges count for the data loss and the limited size of clusters promises the short recreating time. However unlike other compressed method which are used only to save storage, the present invention yields a reduced network which may be used for queries.

Building the reduced 350 is performed as follows:

For each edge in the original network 352, perform the following steps:

If the nodes of the edge are associated to different clusters in the corresponding entry in the list of nodes, set a connection between the two clusters if not already connected 356.

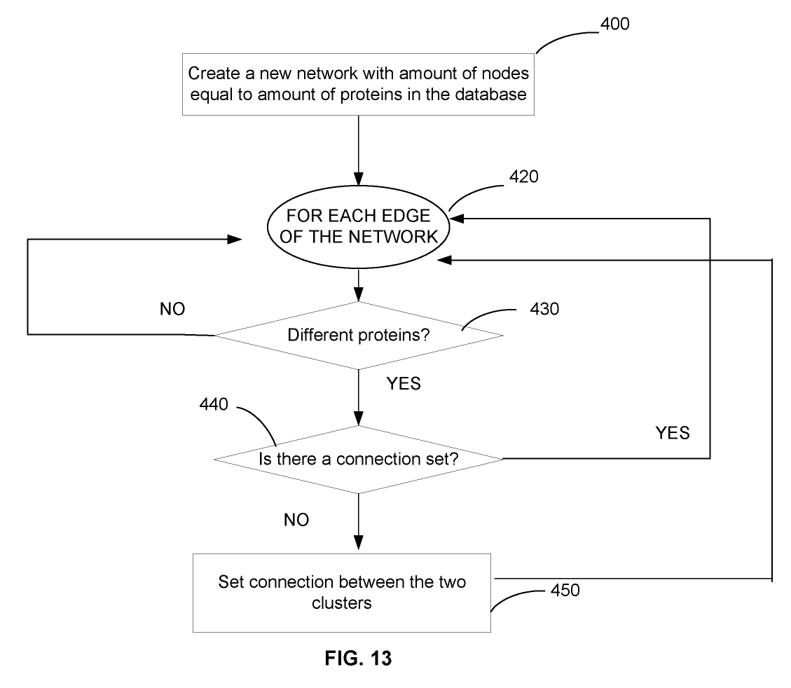

With reference to FIG. 13, there is shown an alternative method to compress the original network into a reduced PCN network consisting of clusters. According to this method all nodes in a cluster are fragments of the same protein sequence. Usually, there are no internal connections between the node inside the cluster, but there are many external connections between the connected clusters since the protein sequences are usually similar in many places.

A. An empty new network with amount of nodes equal to amount of proteins in the protein database is created 400, connection between the nodes is initialized as not connected 410.

B. For each pair of nodes in the original PCN 420, if the nodes belong to different proteins 430 and no connection is set already between them 440, build a connection between the two nodes in the new network 450.

Another exemplary embodiment of a method for network compression is by first building the network e.g. generating the edges, by walking first through the protein sequence space (being part of the input for the other methods described above), applying then clustering algorithm on these edges for generating the list of clusters and then connecting between the clusters, using same steps as in the first method.

The purpose of building first the PCN network is to provide efficient clustering when performing the clustering stage (many internal connections and few external connections).

The input is as follows:

Protein sequence database;

Parameters for the building of the network: size of words and hamming distance threshold for edge setting;

### Building of the Network

The sequence relatedness is commonly established by the observation of high similarity between two compared sequences. If more sequences are found that are related to one of the original sequences, a network can be formed, from connected points (sequences) in the sequence space. By further comparing all the points with all sequences available, keeping the threshold of pair-wise similarity constant, one generates an exhaustive network of sequence kinship.

Building the PCN network is same task as solving the k-mismatch search problem (alternatively called “string matching with k mismatch”. Any algorithm solving “approximate string matching” may be used, particularly the one described in “Evolutionary Networks in Formatted Protein Sequence Space, Journal of computational biology, 2007 October; 14(8):1044-57 by Frenkel, Z. M. and Trifonov, E. N”, Chap 2.2.

It is to be understood that the present invention is not limited to the embodiments described above, but encompasses any and all embodiments within the scope of the following claims. It will be appreciated by persons skilled in the art that the disclosed technique is not limited to what has been particularly shown and described hereinabove. Rather the scope of the disclosed technique is defined only by the claims, which follow.

1. A method of compressing a similarity network characterized by nodes with a plurality of repetitions of characters sequences; and a plurality of edges, each edge connecting a pair of said nodes based on a first similarity threshold; the method comprising clustering of said nodes according to a second similarity threshold, wherein said second similarity threshold is higher than said first similarity threshold.

2. The method of claim 1, wherein the network is a Protein Connectivity Network (“PCN”).

3. The method of claim 1, further comprising:
a) calculating similarity value between the nodes of each edge to identify nodes having similarity above the second similarity threshold value, performing the following steps for the identified nodes:
i) confirming whether the identified nodes are associated to a cluster;
ii) creating new clusters for identified nodes not previously associated to a cluster, wherein said new cluster is assigned as root cluster;
iii) adding an unassociated node to the root cluster of an associated node in case only one node is associated to a cluster, wherein the number of nodes associated to the root cluster of the associated node is less than a predefined value; and
iv) merging two root clusters of the nodes of edge into one of the clusters in case the two nodes are associated to different root clusters, and sum of numbers of nodes associated to these root clusters is less than a predefined value.

4. The method of claim 3, further comprising:
b) creating an empty dynamic list for cluster entries, each cluster entry comprising a pointer variable pointing to a parent cluster (or indicating that the cluster is a root, for the case of pointer is null) and a node number variable corresponding to the number of nodes in a cluster;
c) creating a list of node entries, each node entry comprising a variable indicating the cluster number said node is assigned to, wherein the variable is initialized as unassigned;
d) the creating of new cluster further includes:
i) defining a new entry in the list of clusters, wherein the new cluster entry is defined as a root cluster with number of nodes equal two; and
ii) associating both nodes to the root cluster by associating corresponding nodes entry in the list of nodes to the root cluster.
e) the adding of unassociated node to the root cluster of an associated node further includes:
i) searching for the root cluster of the node already associated to this cluster;
ii) updating the corresponding pointer to the parent cluster in the list of clusters to point to the root cluster; and
iii) adding the node to the cluster when the adding of the unassociated node to the root cluster doesn't exceed the predefined value by:
1. increasing the number of nodes in the corresponding entry in the list of clusters by one; and
2. updating the cluster that the node is associated to, in the corresponding entry of the node.
f) the merging of two root clusters into one of the clusters further includes
i) searching for the root clusters of the both nodes;
ii) calculate the sum of nodes associated with these clusters; if the sum is less than a predefined value, than do:
iv) updating the pointer of the root cluster with larger index in the corresponding root cluster in the list of clusters to point to the other root cluster;
v) setting the number of nodes in the corresponding entry in the list of clusters to the sum of the nodes set in the corresponding clusters in the list of clusters; and
vi) updating the corresponding pointer to the parent cluster in the list of clusters to point to the residuary root cluster, for each cluster passing through when searching for the root clusters.

5. The method of claim 1, further comprising:
a) calculating amount of root clusters;
b) renumbering the clusters;
c) associating of nodes with new numbers of clusters (after renumbering);
d) creating an output file of content of clusters; and
e) building connections between the clusters for each said edge where nodes of said edges are connected to different clusters.

6. A compressed similarity network made by the steps of:
a) receiving a database of proteins;
b) receiving a Protein Connectivity Network (PCN);
c) creating a network with amount of nodes equal to amount of proteins in the protein database,
d) inputting PCN characterized by a plurality of edges;
e) initializing, as unconnected, new nodes, defined as said proteins of said database, in a newly compressed network; connecting between two nodes and thereby making a new connection, wherever the inputted nodes belong to different proteins of said database and there is no prior connection in said new network between the different proteins;
f) discounting said prior connection wherever there is a prior connection in said new network; and outputting a new compressed network.

7. The method of decompression of the compressed network comprising:
a) calculate similarities between each pair of nodes in each cluster;
b) for each pair of nods with similarity higher than the first similarity threshold set the edge; and
c) for each pair of clusters connected by edge in the compressed network:
i) calculate similarities between each pair of nodes from the different clusters;
ii) for each pair of nods with similarity higher than the first similarity threshold set the edge.
